(19) United States
(12) Patent Application Publication
(10) Pub. No.: US 2026/0319898 A1
(43) Pub. Date: Oct. 15, 2026

(54) FAULT-TOLERANT AI ARCHITECTURE WITH DISTRIBUTED PROCESSING AND AUTONOMOUS TASK TRANSITION

(71) Applicant: John Clayton, Northborough, MA (US)

(72) Inventor: John Clayton, Northborough, MA (US)

(21) Appl. No.: 19/177,552

(22) Filed: Apr. 12, 2025

(51) Int. Cl. G06F 11/20

(52) U.S. Cl. CPC G06F 11/2041; G06F 2201/81

(57) ABSTRACT

The described fault-tolerant AI architecture provides a robust solution for maintaining reliability and accuracy in critical AI applications. By leveraging distributed processing, continuous monitoring, probabilistic task success evaluation, and autonomous task transition, the invention addresses the limitations of traditional AI and fault-tolerant systems, which do not evaluate probabilistic task completion metrics, ensuring uninterrupted operation in the face of potential failures.

### FIELD

The present invention relates to artificial intelligence (AI) systems, specifically to a fault-tolerant AI architecture that employs a distributed processing model to enhance reliability and accuracy through autonomous task monitoring and transition among multiple processor modules based on task success probability evaluation. This invention is applicable to domains such as autonomous systems and other mission-critical operations where uninterrupted AI performance is essential.

### BACKGROUND

AI systems are increasingly deployed in critical applications such as autonomous vehicles, medical diagnostics, and financial trading, where reliability and accuracy are paramount. Traditional AI architectures often rely on a single processing unit, making them vulnerable to hardware failures, software bugs, or environmental disruptions. AI systems are fundamentally probabilistic in their task execution. Existing fault-tolerant systems, such as triple modular redundancy (TMR), use majority voting among identical modules but lack dynamic adaptability to varying failure modes, and cannot autonomously reassign tasks based on probabilistic assessments of task success.

A need exists for an AI architecture that evaluates execution success probabilities and autonomously reallocates computational resources in real-time when discrepancies arise. The present invention addresses these needs by introducing a distributed processing model where the component neural networks are trained to predict success likelihood based on inputs and historical outcomes coupled with adaptive task reassignment, improving system reliability in high-stakes environments.

### SUMMARY

The invention provides a fault-tolerant AI architecture comprising three or more AI modules operating in a distributed processing environment in which the AI modules are trained to both perform task execution and to evaluate the probability of task success. The AI modules directly controlling task execution are referred to as execution modules (EMs). The AI modules that do not directly control system task functions are referred to as monitoring modules (MMs). All AI modules calculate the real-time probability of task execution success based on system performance metrics, input data integrity, and historical error rates.

Each AI module employs a probabilistic model to assess the likelihood of task success as a function of time, comparing its assessment with those of other AI modules. If a significant divergence in probability estimates is detected—defined as a difference exceeding a predefined parametric threshold—the AI modules identify the EM or MM as potentially faulty and autonomously transition task execution and system control in the case of a faulty EM to an alternate AI module. If the faulty AI module is an MM, it is autonomously removed from the monitoring functions. The alternate EM is selected based on its alignment with the majority probability assessment and its operational health. Faulty AI modules are then subject to remedial action such as reboots, diagnostics, or isolation from the system.

This architecture ensures continuous operation by mitigating single points of failure, dynamically adapting to detected anomalies, and maintaining high accuracy in task execution. The invention is particularly suited for applications requiring uninterrupted AI performance, such as autonomous systems, real-time analytics, and mission-critical operations.

### BRIEF DESCRIPTION OF THE DRAWINGS

In the following detailed portion of the present description, the teachings of the present application will be explained in more detail with reference to the sample embodiments shown in the drawings, wherein the showings are for the purpose of illustrating the invention only and not for the purpose of limiting the same, in which:

FIG. 1 is a block diagram illustrating the fault-tolerant AI architecture with one EM and two MMs in a distributed processing model controlling machinery according to a first embodiment.

### DETAILED DESCRIPTION OF THE INVENTION

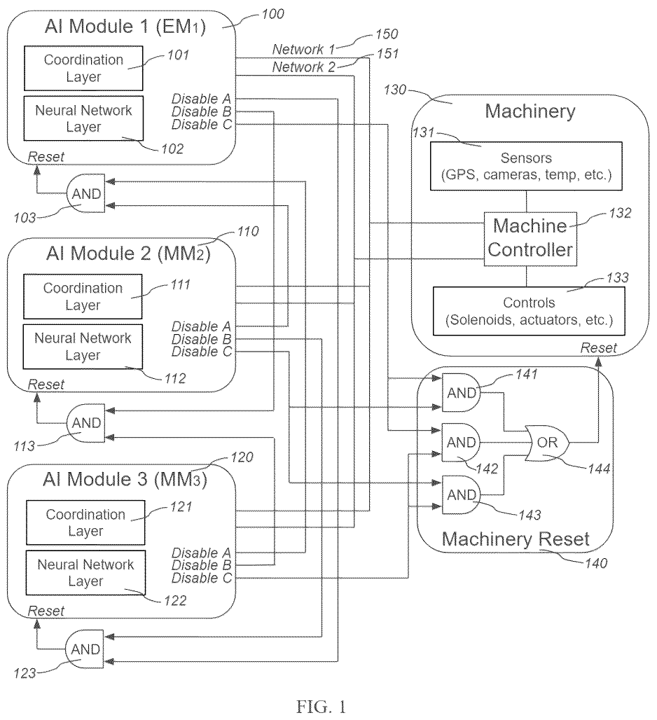

The present invention provides a fault-tolerant AI architecture designed to enhance reliability and accuracy through a distributed processing model. FIG. 1 depicts an exemplary embodiment of the invention with three AI modules 100, 110, 120 monitoring and controlling machinery 130. Each AI module 100, 110, 120 executes on a separate or virtualized processor (e.g., a GPU or TPU).

A distributed software coordination layer 101, 111, 121 aggregates probability scores, detects divergences, and orchestrates task transitions when necessary. A divergence is significant if the difference between any two probability scores exceeds a threshold that is a configurable parameter (e.g., 0.2 for a 20% difference at any time t). The communications among the coordination layers 101, 111, 121 in the three AI modules 100, 110, 120 and machinery 130 is by redundant networks A 150 and B 151, which also provide for data from machinery 130 sensors 131 to be sent to the AI modules 100, 110, 120 as input for the neural networks 102, 112, 122.

Machinery reset 140 logic enables reset and/or shutdown of the machinery 130 if two or more AI modules 100, 110, 120 detect a non-recoverable fault condition and assert their respective disable C outputs. The combinatorial logic 141, 142, 143, and 144 implement the aforementioned disable function.

The first AI module 100 is configured as an Execution Module (EM1, where the module index corresponds to the AI module index) which executes AI tasks in a neural network layer 102, running a trained neural network for image recognition, decision-making, machine control, and execution success probability analysis. It receives input data from machinery 130 sensors 131 via the machine controller 132, processes it in the neural network 102, and generates both an execution success probability and outputs to control the machinery 130 via the machine controller 132, which operates machine controls 133.

The second and third AI modules 110, 120 are configured as Monitoring Modules (MM2, MM3 where the module index corresponds to the AI module index). Like the EM, each MM receives input data from machinery 130 sensors 131 via the machine controller 132, processes it in the neural networks 112, 122, and generates an execution success probability with respect to time. Unlike the EM, the MMs generate no control outputs for the machinery 130.

The EM and MMs neural networks 102 each independently and continuously evaluate current execution success Pi(t) (where i is the module index an t is time), representing the likelihood of successful EM task completion with respect to time, based on parameters such as:
EM Performance Metrics: Latency, throughput, completion of sub-tasks, and error rates.
Input Data Content and Integrity: Statistical analysis of input data for content and anomalies (e.g., outliers, noise).
Historical Error Rates: A Bayesian or other probabilistic model incorporating past performance to predict future reliability.

If two EMs or MMs detect a significant divergence in probability estimates from a third EM or MM, they reset and/or shutdown that potentially faulty AI module by asserting their disable A or B output that is connected to the potentially faulty AI module. The combinatorial logic 103, 113, 113 implements the aforementioned reset and/or shutdown function. In the case of a potentially faulty EM, the coordination layer selects an MM to take over the function of the faulty EM based on:
The MM with the highest task success probability assessment (e.g., the module whose Pi(t) shows task completion in the shortest time).
Operational health (e.g., CPU load, memory availability).

The advantages of this invention over prior art include:
The distribution of task execution and monitoring across multiple AI modules avoids single points of failure.
Probabilistic evaluation and autonomous task transition enable real-time response to potential failures.
Additional EMs and MMs can be added to increase redundancy without altering the core architecture.
Continuous monitoring ensures tasks are executed by the most reliable AI module(s), maintaining output quality.

The system can be implemented using existing hardware (e.g., multi-core CPUs, GPUs) and software frameworks (e.g., TensorFlow for AI tasks, Kubernetes for distributed orchestration). The probabilistic model can be tailored to specific applications, incorporating domain-specific features (e.g., autonomous machinery control, sensor noise in autonomous vehicles, packet loss in network systems).

1. A fault-tolerant artificial intelligence (AI) architecture, comprising:
one or more execution modules (EMs) configured to process AI tasks;
at least two monitoring modules (MMs), each configured to continuously evaluate the probability of successful task execution as a function of time by the EMs,;
a coordination layer configured to detect a significant divergence in the probabilities evaluated by the MMs and, upon detection, autonomously transition task execution to an alternate EM.

2. The architecture of claim 1, wherein EMs and MMs operate on separate or virtualized processors to ensure or enhance independence.

3. The architecture of claim 1, wherein each MM evaluates the probability of successful task execution as a function of time based on performance metrics, sub-task completion, input data content and integrity, and historical error rates.

4. The architecture of claim 3, wherein EMs also perform the same monitoring on their performance as an MM, and participate in the evaluation of successful task execution probability.

5. The architecture of claim 1, wherein a significant divergence is detected when the difference between any two probability scores exceeds a predefined threshold of task completion time, probability of success, or combination thereof.

6. The architecture of claim 1, wherein an alternate EM is selected based on it having the lowest task completion time, the highest probability of success, its operational health, or some predefined combination thereof.

7. The architecture of claim 1, wherein MMs can convert to EMs in the event of EM failure.

8. The architecture of claim 1, wherein an MM is removed from the system based on it having a significant divergence from at least two other MM or EM probability scores.

9. The architecture of claim 1, wherein the coordination layer uses a secure communication protocol to facilitate real-time interaction among the EMs and MMs, and other system components.
